(19) United States
(12) Patent Application Publication
(10) Pub. No.: US 2015/0000113 A1
(43) Pub. Date: Jan. 1, 2015

(54) Induction Device

(71) Applicant: KABUSHIKI KAISHA TOYOTA JIDOSHOKKI, Aichi-ken (JP)

(72) Inventor: Hiroshi Ono, Aichi-ken (JP)

(21) Appl. No.: 14/317,476

(22) Filed: Jun. 27, 2014

Related U.S. Application Data
(63) Continuation of application No. 13/274,832, filed on Oct. 17, 2011, now abandoned.

(30) Foreign Application Priority Data
Oct. 22, 2010 (JP) 2010-237929

(51) Int. Cl. H01F 41/02; H01F 41/00; H01F 27/02

(52) U.S. Cl. CPC H01F 41/02; H01F 27/02; H01F 41/00
USPC 29/602.1

(57) ABSTRACT

A method of producing an induction device includes the steps of a forming a coil and core assembly, forming rectangular holes, and press-fitting a second core. An induction device includes a first core, a coil wound around the first core, and a second core cooperating with the first core to form a closed magnetic circuit. The first core and the coil are molded by a mold resin to form a molding, and the second core is assembled to the molding.

### CROSS REFERENCE TO RELATED APPLICATIONS

This application is a Continuation of U.S. patent application Ser. No. 13/274,832 filed Oct. 17, 2011, which claims priority to Japanese Application No. 2010-237929 filed on Oct. 22, 2010.

### BACKGROUND

The present invention relates to an induction device.

Japanese Unexamined Patent Application Publication No. 11-345715 discloses an induction device embodied as a small transformer in which the coil is wound around the cylindrical bobbin to which the paired E-type cores are assembled so that the center legs of the respective E-type cores are inserted in the bobbin and the outer legs of the respective E-type cores are located outside the coil. The ends of the legs of the respective E-type cores are set in contact with each other. Each E-type core is coated on the entire surface thereof with electrically insulating synthetic resin so as to form a gap between the ends of the center and outer legs of the respective E-type cores.

However, it is troublesome to assemble the E-typed cores to the bobbin on which the coil is wound, and such structure makes it difficult to position the bobbin and the E-typed cores precisely in place relative to each other.

The present invention is directed to providing an induction device with easily manufacturable structure that makes it easy to accomplish precise positioning of the coil and the core relative to each other.

### SUMMARY

In accordance with an aspect of the present invention, an induction device includes a first core, a coil wound around the first core, and a second core cooperating with the first core to form a closed magnetic circuit. The first core and the coil are molded by a mold resin to form a molding, and the second core is assembled to the molding.

Other aspects and advantages of the invention will become apparent from the following description, taken in conjunction with the accompanying drawings, illustrating by way of example the principles of the invention.

### BRIEF DESCRIPTION OF THE DRAWINGS

FIG. 1A is a plan view of an induction device embodied as a reactor according to a first embodiment of the present invention;

FIG. 1B is a front view of the reactor of FIG. 1A;

FIG. 1C is a side view of the reactor of FIG. 1A;

FIG. 2A is a plane sectional view of the reactor;

FIG. 2B is a sectional view taken along the line IIB-IIB of FIG. 2A;

FIG. 2C is a sectional view taken along the line IIC-IIC of FIG. 2A;

FIG. 3 is an exploded perspective view of the reactor;

FIG. 4A is a plan view of a coil and core assembly of the reactor;

FIG. 4B is a front view of the coil and core assembly;

FIG. 4C is a side view of the coil and core assembly;

FIG. 5A is a plane sectional view of the coil and core assembly;

FIG. 5B is a sectional view taken along the line VB-VB of FIG. 5A;

FIG. 5C is a sectional view taken along the line VC-VC of FIG. 5A;

FIG. 6A is a plane sectional view of a second embodiment of the reactor according to the present invention;

FIG. 6B is a sectional view taken along the line VIB-VIB of FIG. 6A;

FIG. 6C is a sectional view taken along the line VIC-VIC of FIG. 6A;

FIG. 7A is a plane sectional view of the coil and core assembly of the reactor of the second embodiment;

FIG. 7B is a sectional view taken along the line VIIB-VIIB of FIG. 7A;

FIG. 7C is a sectional view taken along the line VIIC-VIIC of FIG. 7A;

FIG. 8A is a plan view of another embodiment of the reactor according to the present invention;

FIG. 8B is a front view of the reactor of FIG. 8A;

FIG. 8C is a side view of the reactor of FIG. 8A;

FIG. 9 is an exploded perspective view of the reactor of FIGS. 8A, 8B and 8C; and

FIG. 10 is an exploded perspective view of still another embodiment of the reactor according to the present invention.

### DETAILED DESCRIPTION OF ILLUSTRATIVE EMBODIMENTS

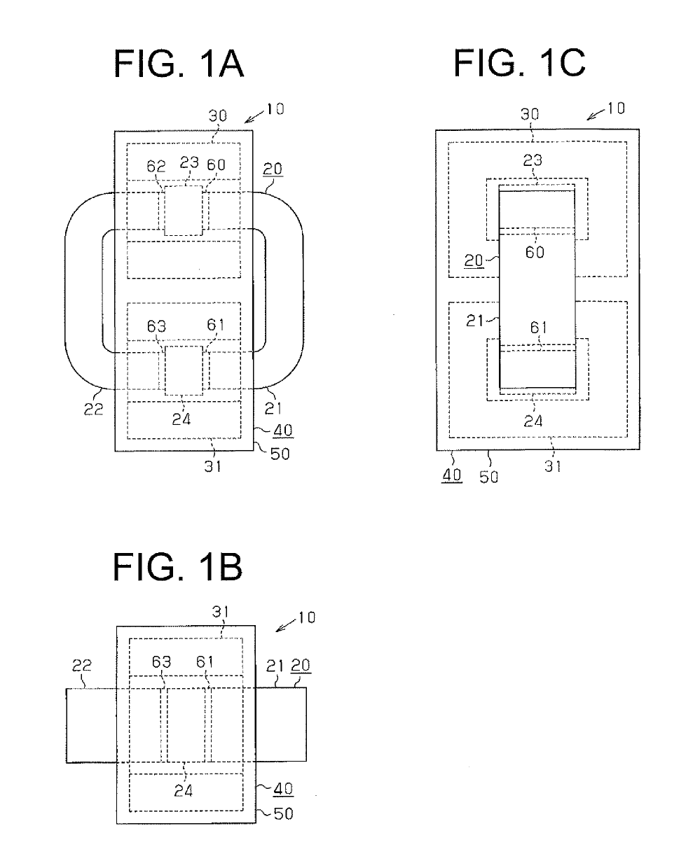

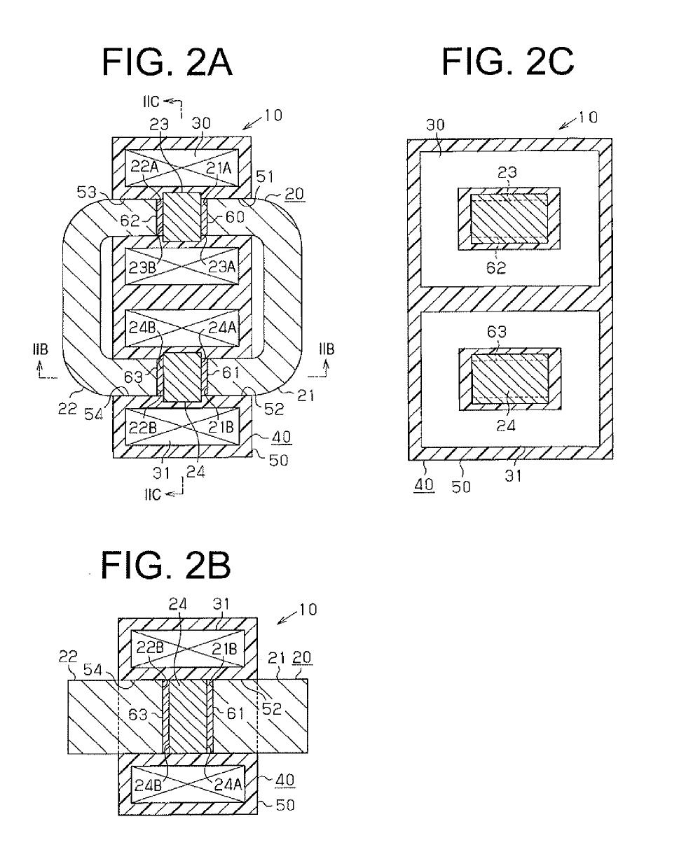

The following will describe the embodiments of the induction device according to the present invention with reference to the accompanying drawings. FIGS. 1A, 1B and 1C are plan, front and side views, respectively, of the first embodiment of the induction device embodied as a reactor. FIG. 2A is a plane sectional view of the reactor, and FIGS. 2B and 2C are sectional views taken along the lines IIB-IIB and IIC-IIC, respectively, of FIG. 2A.

The reactor designated generally by 10 has a U-I-U core 20 and coils 30, 31. The U-I-U core 20 is formed by a U-type core 21, a U-type core 22, an I-type core 23, and an I-type core 24.

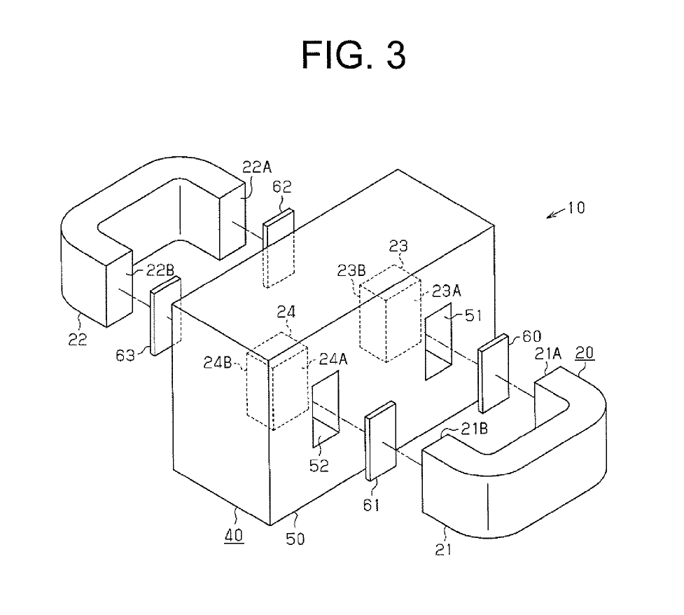

The coils 30, 31 and the I-type cores 23, 24 (first core) are molded by a mold resin 50, thereby forming a coil and core assembly 40 (molding). Referring to FIG. 3, wherein coils are not illustrated for simplification, ceramic spacers 60, 61, 62, 63 and the U-type cores 21, 22 (second core) are assembled to the coil and core assembly 40 in manufacturing the reactor 10.

The U-type core 21 is formed by a U-shaped member of a rectangular cross section having ends 21A, 21B, as shown in FIG. 3. Similarly, the U-type core 22 is formed by a U-shaped member of a rectangular cross section having ends 22A, 22B. The I-type core 23 is formed by a straight member of a rectangular cross section having ends 23A, 23B. Similarly, the I-type core 24 is formed by a straight member of a rectangular cross section having ends 24A, 24B.

The ceramic spacer 60 is provided between the end 21A of the U-type core 21 and the end 23A of the I-type core 23 to be set in contact therewith. The ceramic spacer 61 is provided between the end 21B of the U-type core 21 and the end 24A of the I-type core 24 to be set in contact therewith.

Similarly, the ceramic spacer 62 is provided between the end 22A of the U-type core 22 and the end 23B of the I-type core 23 to be set in contact therewith. The ceramic spacer 63 is provided between the end 22B of the U-type core 22 and the end 24B of the I-type core 24 to be set in contact therewith. In this way, the ceramic spacers 60, 61, 62, 63 are disposed in a closed magnetic circuit created by the U-I-U core 20.

In the present embodiment, the ceramic spacers 60, 61, 62, 63 each having a rectangular shape and provided separately from the mold resin 50 are used to create a gap in the magnetic circuit. The ceramic spacers 60, 61, 62, 63 are bonded to their associated ends 21A, 21B, 22A, 22B of the respective U-type cores 21, 22 and also to the ends 23A, 23B, 24A, 24B of the respective I-type cores 23, 24.

As shown in FIGS. 2A, 2B and 2C, the coil 30 is wound into a rectangularly annular shape around the I-type core 23 and one ends of the U-type cores 21, 22, and similarly the coil 31 is wound into a rectangularly annular shape around the I-type core 24 and the other ends of the U-type cores 21, 22.

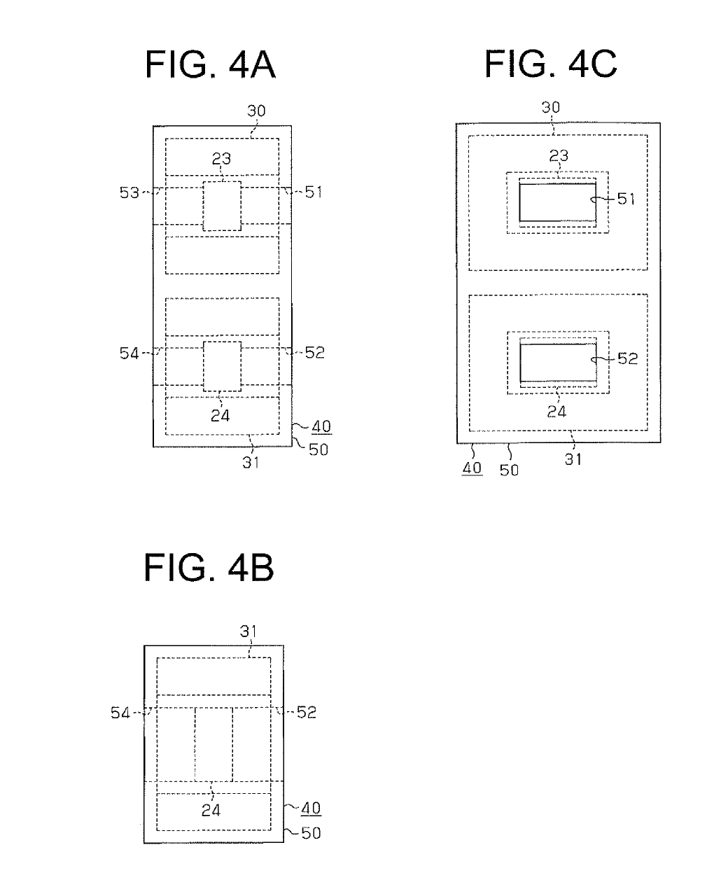

Although not shown in the drawings, the coils 30, 31 are connected each other at one ends thereof, and have terminals at the other ends thereof. FIGS. 4A, 4B and 4C are plan, front and side views, respectively, of the coil and core assembly 40.

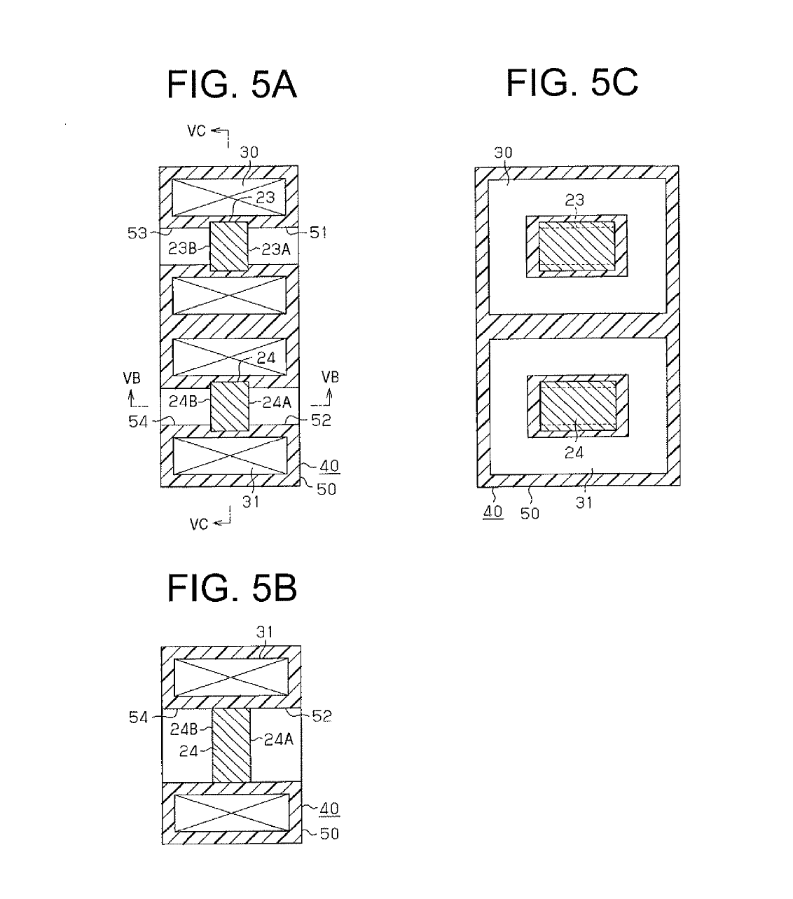

FIG. 5A is a plane sectional view of the coil and core assembly 40, and FIGS. 5B and 5C are sectional views taken along the lines VB-VB and VC-VC, respectively, of FIG. 5A. As shown in the drawings, the coil and core assembly 40 is molded in such a way that the coils 30, 31 and the I-type cores 23, 24 are coated over the peripheries thereof with the mold resin 50.

The coil and core assembly 40 has rectangular holes 51, 52, 53, 54 located radially inward of the respective coils 30, 31 for mounting of the U-type cores 21, 22. The size of the holes 51, 52, 53, 54 is slightly smaller than that of the ends of the respective U-type cores 21, 22 so that the U-type cores 21, 22 are press fit into their associated holes 51, 52, 53, 54. The holes 51, 52, 53, 54 formed in the coil and core assembly 40 serve to position and fix the U-type cores 21, 22 in such a manner that the outer surfaces of the ends of the U-type cores 21, 22 are set in contact with the inner surfaces of the associated holes 51, 52, 53, 54.

As shown in FIG. 5A, the I-type cores 23, 24 are held in position radially inward of the coils 30, 31 by being molded integrally with the coils 30, 31 by the mold resin 50.

The following will describe the process for manufacturing the reactor 10. The coils 30, 31, the ceramic spacers 60, 61, 62, 63, the U-type cores 21, 22 and the I-type cores 23, 24 are prepared. The coils 30, 31 and the I-type cores 23, 24 are molded by the mold resin 50 thereby to form the coil and core assembly 40, as shown in FIG. 4A.

The ceramic spacers 60, 61 are bonded at one surfaces thereof to the opposite ends 21A, 21B of the U-type core 21 by adhesive, and adhesive is previously applied to the other surfaces of the respective ceramic spacers 60, 61. Similarly, the ceramic spacers 62, 63 are bonded at one surfaces thereof to the opposite ends 22A, 22B of the U-type core 22 by adhesive, and adhesive is previously applied to the other surfaces of the respective ceramic spacers 62, 63.

Then the U-type core 21 having the ceramic spacers 60, 61 bonded thereto is press fit into the holes 51, 52 of the coil and core assembly 40, and the U-type core 22 having the ceramic spacers 62, 63 bonded thereto is press fit into the holes 53, 54 of the coil and core assembly 40.

By doing so, the ceramic spacer 60 is positioned between the ends 21A, 23A of the respective cores 21, 23, and the ceramic spacer 61 is positioned between the ends 21B, 24A of the respective cores 21, 24. The ceramic spacer 62 is positioned between the ends 22A, 23B of the respective cores 22, 23, and the ceramic spacer 63 is positioned between the ends 22B, 24B of the respective cores 22, 24.

As a result of the above process, the reactor 10 as shown in FIG. 1A is completed. The use of ceramic as the material for the spacers 60, 61, 62, 63 helps to prevent the creep of the spacer due to the cyclic stress or the magnetic attraction force repeatedly acting between the U-type cores 21, 22 during the operation of the reactor, and also results in a reduction of NV (Noise and Vibration) because of the increased rigidity of the spacer, as compared to the case that the spacer is made of resin.

The reactor 10 of the present embodiment allows the U-type cores 21, 22, the I-type cores 23, 24, the coils 30, 31 and the ceramic spacers 60, 61, 62, 63 to be positioned and fixed precisely relative to each other, thereby resulting in a reduced coil loss and inductance variation.

The above embodiment may be modified in such a way that after the U-type cores 21, 22 are press fit into the coil and core assembly 40, the U-type cores 21, 22 are molded by resin.

As described above, the reactor 10 of the present embodiment has the I-type cores 23, 24 (first core), the coils 30, 31 wound around the I-type cores 23, 24, and the U-type cores 21, 22 (second core) cooperating with the I-type cores 23, 24 to form a closed magnetic circuit. The I-type cores 23, 24 and the coils 30, 31 are molded by the mold resin 50 thereby to form the coil and core assembly 40 (molding). The U-type cores 21, 22 are press fit in the coil and core assembly 40. In such structure, the U-type cores 21, 22 are assembled to the coil and core assembly 40, thereby cooperating with the I-type cores 23, 24 to form a closed magnetic circuit, which makes it easy to manufacture the reactor 10, as compared to the case when plural cores such as the I-type cores 23, 24 and the U-type cores 21, 22 are individually assembled to a bobbin. The I-type cores 23, 24 and the coils 30, 31 are positioned and fixed by the mold resin 50 in the coil and core assembly 40 and the U-type cores 21, 22 are assembled to the coil and core assembly 40, which makes it easy to position and fix the coils 30, 31, the I-type cores 23, 24 and the U-type cores 21, 22 precisely relative to each other without using any means other than the mold resin 50.

Thus the present invention facilitates the manufacturing of the reactor 10 and also allows the coils 30, 31 and the U-I-U core 20 including the U-type cores 21, 22 and the I-type cores 23, 24 to be positioned and fixed easily and precisely.

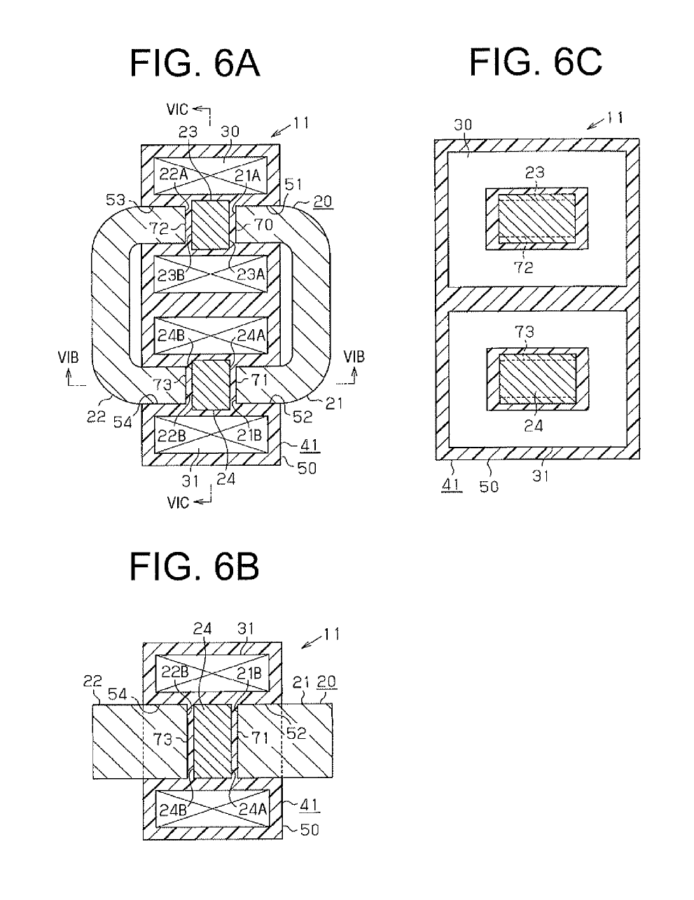

FIG. 6A is a plane sectional view of the second embodiment of the reactor designated by 11. FIGS. 6B and 6C are sectional views taken along the lines VIB-VIB and VIC-VIC, respectively, of FIG. 6A.

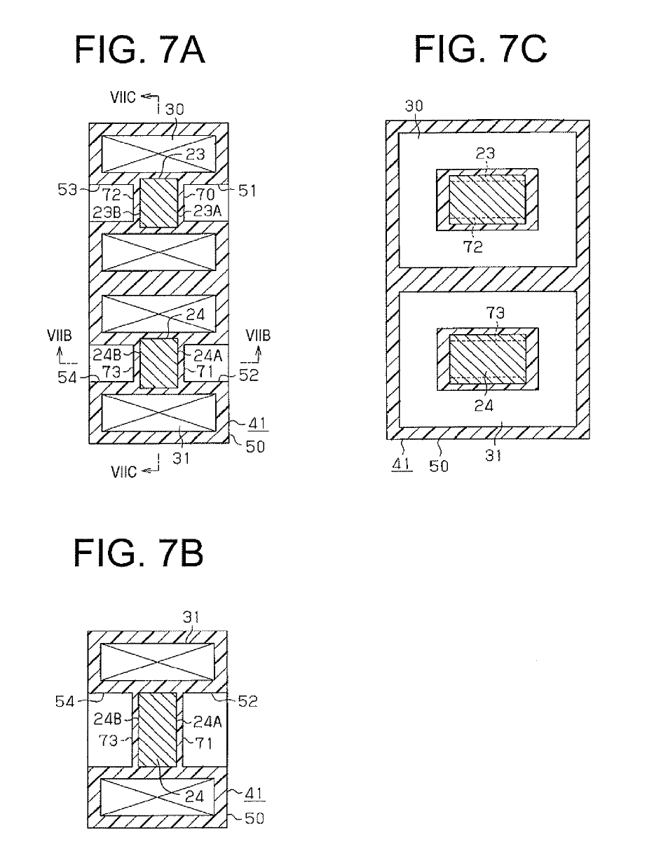

FIG. 7A is a plane sectional view of the second embodiment of the coil and core assembly designated by 41. FIGS. 7B and 7C are sectional views taken along the lines VIIB-VIIB and VIIC-VIIC, respectively, of FIG. 7A.

As shown in FIGS. 7A, 7B and 7C, the reactor 11 has resin spacers 70, 71, 72, 73 molded integrally with the coil and core assembly 41 of the reactor 11. The spacers 70, 72 are molded on the respective ends 23A, 23B of the I-type core 23, and the spacers 71, 73 are molded on the respective ends 24A, 24B of the I-type core 24. As shown in FIGS. 6A, 6B and 6C, the closed magnetic circuit having therein the spacers 70, 71, 72, 73 is formed by assembling the U-type cores 21, 22 to the coil and core assembly 41. The reactor 11 of the second embodiment also can be manufactured easily, as compared to the case when plural components such as the I-type cores 23, 24, the U-type cores 21, 22 and the spacers 70, 71, 72, 73 are individually assembled to a bobbin.

The I-type cores 23, 24, the spacers 70, 71, 72, 73 and the coils 30, 31 are positioned and fixed by the mold resin 50 in the coil and core assembly 41 and the U-type cores 21, 22 are assembled to the coil and core assembly 41, which makes it easy to position and fix the coils 30, 31, the I-type cores 23, 24, the U-type cores 21, 22 and the spacers 70, 71, 72, 73 precisely relative to each other.

The provision of the spacers 70, 71, 72, 73 which are formed by using a part of the mold resin 50 makes it easy to create a gap in the magnetic circuit, as compared to the case that the spacers are formed by additional members other than the mold resin 50. Furthermore, the use of such spacers 70, 71, 72, 73 requires no adhesive for bonding the spacers as in the first embodiment, resulting in a reduced manufacturing cost.

The above embodiments may be modified in various ways as exemplified below.

In the first embodiment of FIG. 2, the ceramic spacers 60, 61, 62, 63 may be molded integrally with the coil and core assembly 40 by the mold resin 50.

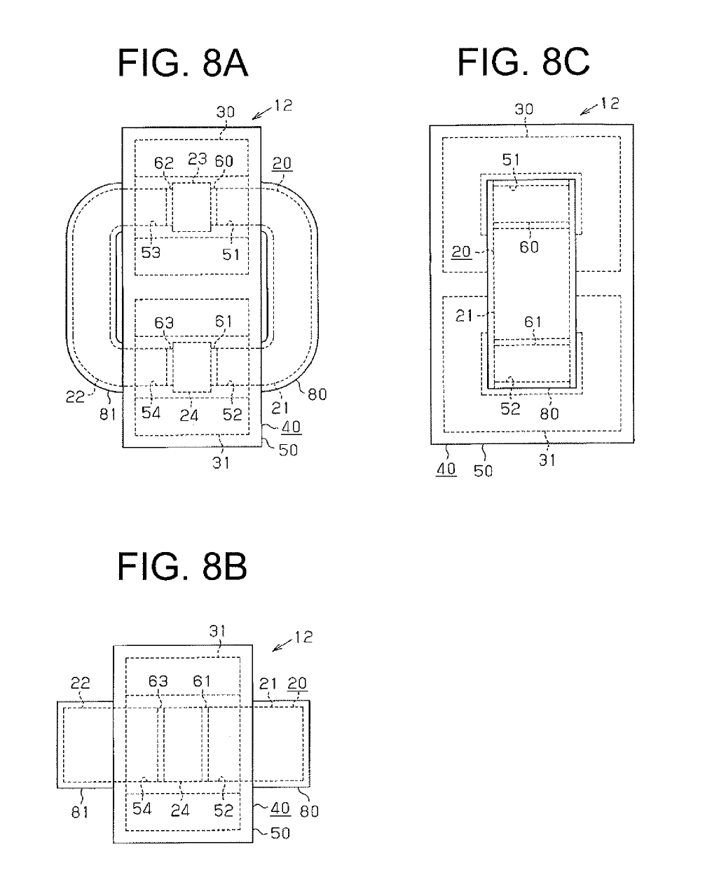

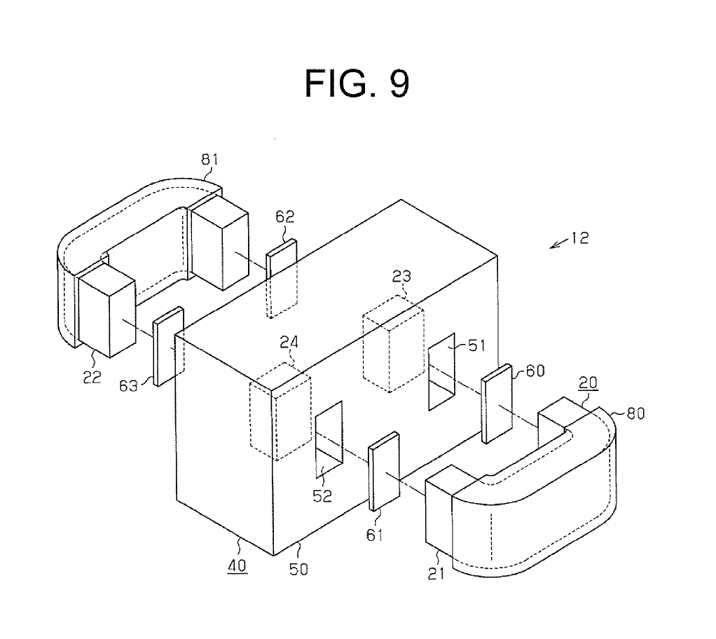

As shown in FIGS. 8A, 8B and 8C, the U-type cores 21, 22 which are molded by mold resins 80, 81, respectively, may be press fit into the holes 51, 52, 53, 54 of the coil and core assembly 40. Specifically, as shown in FIG. 9 wherein coils are not illustrated for simplification, the U-type cores 21, 22 are previously molded by the mold resins 80, 81 except the parts thereof that are to be inserted in the associated holes 51, 52, 53, 54, and then such partially resin-molded U-type cores 21, 22 are press fit into the holes 51, 52, 53, 54 of the coil and core assembly 40.

Alternatively, the U-type cores 21, 22 entirely coated with resin may be press fit into the holes 51, 52, 53, 54 of the coil and core assembly 40.

Although in the first embodiment two I-type cores, namely the I-type cores 23, 24, are molded in the coil and core assembly 40, the number of I-type cores to be molded in the coil and core assembly 40 is not limited to two. For example, four I-type cores may be molded in the coil and core assembly 40.

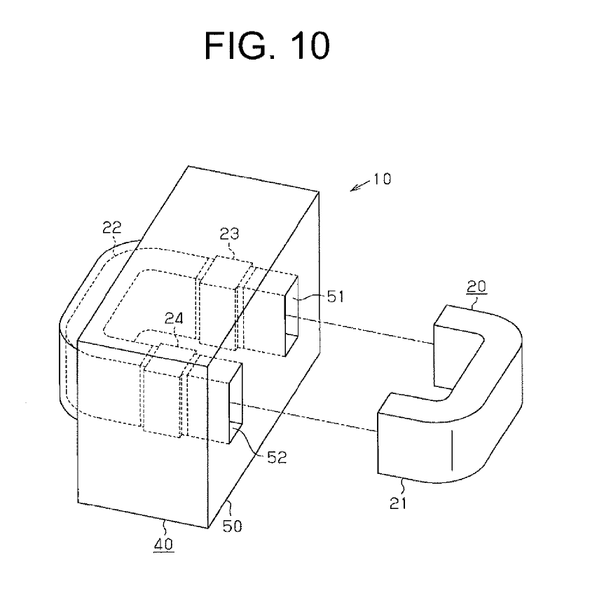

As shown in FIG. 10, one U-type core 22 may be previously molded integrally with the coil and core assembly 40 and the other U-type core 21 may be press fit into the holes 51, 52 of the coil and core assembly 40.

In this case, the closed magnetic circuit can be easily made by assembling the U-type core 21 to the coil and core assembly 40 including the U-type core 22 and the I-type cores 23, 24 molded by the mold resin 50, which facilitates the manufacturing of the reactor 10, as compared to the case when plural components such as the I-type cores 23, 24 and the U-type cores 21, 22 are individually assembled to a bobbin. The U-type core 22, the I-type cores 23, 24 and the coils 30, 31 are positioned and fixed by the mold resin 50 in the coil and core assembly 40 and the U-type core 21 is assembled to the coil and core assembly 40, which makes it easy to position and fix the coils 30, 31, the I-type cores 23, 24 and the U-type cores 21, 22 precisely relative to each other.

A U-U core may be formed by assembling the U-type core 21 to the assembly of the U-type core 22 and the coils (not shown) molded by the mold resin 50. In this case, the mold resin 50 needs to be applied at least around the ends of the U-type cores 22 and the coils wound therearound.

The U-type cores 21, 22 may be fixed to the coil and core assembly 40 not only by press fitting but also by any other suitable method. For example, with the U-type cores 21, 22 positioned in place on the coil and core assembly 40 including the coils 30, 31 and the I-type cores 23, 24 molded by the mold resin 50, the U-type cores 21, 22 and such coil and core assembly 40 may be further molded by resin.

The present invention may be applied not only to a U-I-U core but also to an E-I-E core. The induction device may be embodied not only as a reactor but also as a transformer.

1. A method of producing an induction device, comprising the steps of:
forming a coil and core assembly by integrally molding said coil and a first core by a mold resin adapted to hold the first core in position radially inward of said coil;
forming a rectangular hole in said coil and core assembly adapted for mounting a second core; and
press-fitting said second core into the rectangular hole of the coil and core assembly so as to provide a gap between the first core and the second core.

2. The method according to claim 1, further comprising positioning a spacer at one surface thereof to opposite ends of the second core when the second core is press fit into the rectangular hole.

3. The method according to claim 1, wherein the gap is formed by a resin in a side facing the second core and the first core.

4. The method according to claim 1, wherein the second core is molded by the mold resin except for the part thereof that is adapted for insertion into the rectangular hole.
